(19) United States
(12) Patent Application Publication
(10) Pub. No.: US 2025/0140944 A1
(43) Pub. Date: May 1, 2025

(54) BATTERY SYSTEM

(71) Applicant: TOYOTA JIDOSHA KABUSHIKI KAISHA, Toyota-shi (JP)

(72) Inventors: Hiroshi YOSHIDA, Anjo-shi (JP); Takashi OGURA, Seto-shi (JP); Yuki SUGO, Seto-shi (JP)

(73) Assignee: TOYOTA JIDOSHA KABUSHIKI KAISHA, Toyota-shi (JP)

(21) Appl. No.: 18/889,819

(22) Filed: Sep. 19, 2024

(30) Foreign Application Priority Data
Oct. 31, 2023 (JP) 2023-186419

(51) Int. Cl. H01M 10/42; B60L 53/80; B60L 58/12; B60L 58/16; H01M 10/48

(52) U.S. Cl. CPC H01M 10/425; B60L 58/12; B60L 58/16; H01M 10/48; B60L 53/80; H01M 2220/20

(57) ABSTRACT

The battery system includes a battery and a control device for estimating an SOC of the battery. When SMR is not connected when the replacement of the battery is detected, SOC is estimated based on SOC-OCV property from the voltage of the unit cell when the battery ECU is activated. When SMR is connected, the SOC estimated from the voltage is corrected using an integrated value of current charged or discharged via SMR, and SOC is estimated.

### CROSS-REFERENCE TO RELATED APPLICATION

This application claims priority to Japanese Patent Application No. 2023-186419 filed on Oct. 31, 2023, incorporated herein by reference in its entirety.

### BACKGROUND

### 1. Technical Field

The present disclosure relates to a battery system.

### 2. Description of Related Art

Japanese Unexamined Patent Application Publication No. 2018-63115 (JP 2018-63115 A) discloses a technique of appropriately estimating a state of charge (SOC) of a secondary battery with a wide plateau area. The plateau area is an area in which an open circuit voltage (OCV) of a secondary battery hardly varies even when the SOC varies, and is also referred to as a “flat voltage area” in the present disclosure. In JP 2018-63115 A, the internal resistance of the secondary battery is calculated from the current and the voltage at the time of charging and discharging, and the SOC is estimated using the relationship between the internal resistance and the SOC.

### SUMMARY

In general, the SOC of a secondary battery is calculated by a control device that includes an input device, a central processing unit (CPU), a memory, etc. In a battery system constituted from a battery (secondary battery), a control device, etc., the battery is occasionally replaced. When replacing the battery, it is desired to estimate an SOC of the battery after the replacement.

In JP 2018-63115 A, an SOC is estimated by obtaining the internal resistance of the battery from a current and a voltage at the time of charging and discharging. In order to obtain the internal resistance of the battery, however, a sufficient period of time is required after the battery is replaced, and an SOC cannot be estimated at the same time as the battery is replaced.

It is an object of the present disclosure to estimate an SOC of a battery when the battery is replaced.

An aspect of the present disclosure provides a battery system including: a battery; a voltage sensor that detects a voltage of the battery; and a control device that estimates a state of charge (SOC) of the battery. When it is detected that the battery has been replaced, the control device estimates the SOC based on an SOC-open circuit voltage (OCV) property of the battery using the voltage detected by the voltage sensor. When a relay that connects the battery and a load is connected when it is detected that the battery has been replaced, in addition, the control device corrects the SOC estimated based on the SOC-OCV property based on a current discharged or charged via the relay.

According to this configuration, when the battery has been replaced, the control device estimates the SOC based on the SOC-OCV property using the voltage detected by the voltage sensor. When a relay that connects the battery and a load is connected when it is detected that the battery has been replaced, there is a possibility that the battery after the replacement has been discharged, or that the battery after the replacement has been charged. When a relay that connects the battery and a load is connected when it is detected that the battery has been replaced, the SOC can be estimated more accurately by correcting the SOC based on the current discharged or charged via the relay.

In addition, the battery system according to the aspect of the present disclosure includes: a battery; a voltage sensor that detects a voltage of the battery; and a control device that estimates a state of charge (SOC) of the battery. The control device is configured to, when the battery has been replaced, estimate the SOC based on the SOC-OCV property of the battery using the voltage detected by the voltage sensor, and correct the SOC using a full charge capacity in the SOC-OCV property and a degradation-time full charge capacity as a full charge capacity at a time when the battery is degraded; and the degradation-time full charge capacity is set in advance.

When the battery is replaced, a used product or a rebuilt product is occasionally used as the replacement battery. According to this configuration, when the battery has been replaced, the control device estimates the SOC based on the SOC-OCV property of the battery using the voltage detected by the voltage sensor. Then, the SOC is corrected using the full charge capacity in the SOC-OCV property and the degradation-time full charge capacity set in advance. Consequently, the SOC can be estimated more accurately even when a degraded battery with a reduced full charge capacity is used.

According to the present disclosure, it is possible to estimate an SOC of a battery when the battery is replaced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an entire configuration diagram of an electrified vehicle in which a battery system according to the present embodiment is mounted;

FIG. 2 is a diagram for explaining SOC-OCV properties of the unit cell (LFP cell) of the present embodiment;

FIG. 3 is a flow chart illustrating an exemplary replacement time SOC estimation process performed by the battery electronic control unit (ECU) in the present embodiment;

FIG. 4 is a flow chart illustrating an exemplary input/output current integration process performed in the cell ECU;

FIG. 5 is a diagram illustrating a part of a flow chart of a replacement time SOC estimation process executed in a battery ECU in Embodiment 2; and

FIG. 6 is a diagram for explaining an SOC-OCV property after replacement of a battery.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

### First Embodiment

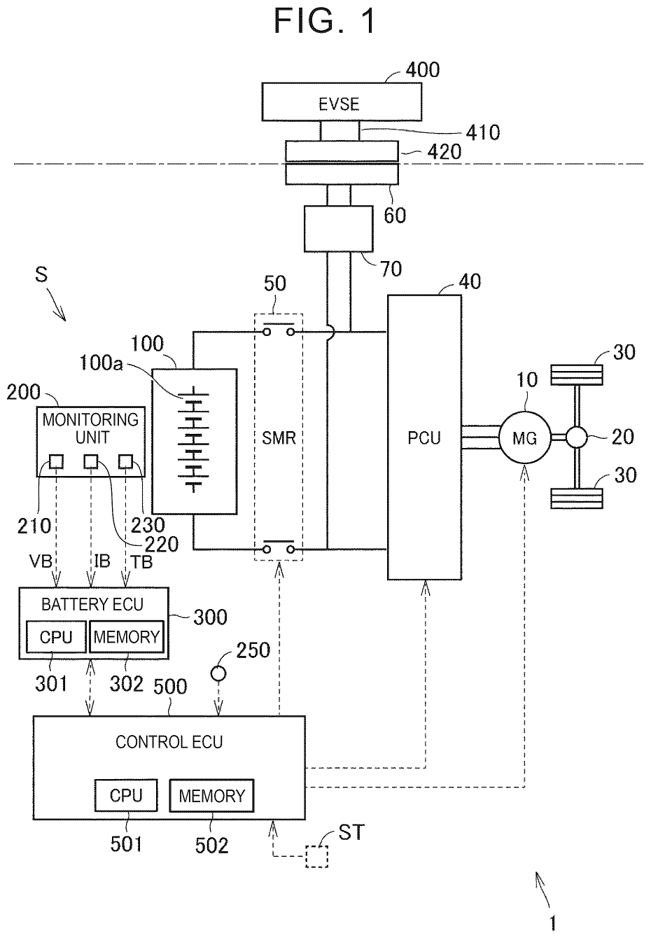

FIG. 1 is an entire configuration diagram of an electrified vehicle 1 in which a battery system S according to the present embodiment is mounted. In the present embodiment, electrified vehicle 1 is, for example, a battery electric vehicle. Electrified vehicle 1 includes a motor generator (MG) 10 which is a rotary electric machine, power transmission gears 20, drive wheels 30, a power control unit (PCU) 40, a system main relay (SMR) 50, a battery 100, a monitoring unit 200, a battery electronic control unit (ECU) 300 which is an exemplary control device, and a control ECU 500.

MG 10 is, for example, an embedded-structure permanent-magnet synchronous motor (IPM motor), and has a function as an electric motor and a function as a generator. The output-torque of MG 10 is transmitted to the drive wheels 30 via the power transmission gears 20 including a speed reducer, a differential, and the like.

When electrified vehicle 1 is braked, MG 10 is driven by the drive wheels 30, and MG 10 operates as a generator. As a result, MG 10 also functions as a braking device that performs regenerative braking for converting kinetic energy of electrified vehicle 1 into electric power. The regenerative electric power generated by the regenerative braking force in MG 10 is stored in the battery 100.

PCU 40 is a power converter that bi-directionally converts power between MG 10 and the battery 100. PCU 40 includes, for example, inverters and converters that operate based on control signals from the control ECU 500.

When the battery 100 is discharged, the converter steps up voltage supplied from the battery 100 and supplies the stepped-up voltage to the inverter. The inverter converts direct current (DC) power supplied from the converter into alternating current (AC) power to drive MG 10.

When the battery 100 is charged, the inverter converts AC power generated by MG 10 into DC power and supplies the DC power to the converter. The converter steps down voltage supplied from the inverter to voltage suitable for charging the battery 100 and supplies the stepped-down voltage to the battery 100.

SMR 50 is electrically connected to a power line connecting the battery 100 and PCU 40. If SMR 50 is ON (i.e., connected) in response to a control signal from the control ECU 500, power may be exchanged between the battery 100 and PCU 40. On the other hand, if SMR 50 is OFF (i.e., disconnected) in response to a control signal from the control ECU 500, the battery 100 is disconnected from PCU 40.

The battery 100 stores electric power for driving MG 10. The battery 100 is a rechargeable DC power source (secondary battery), and is an assembled battery in which a plurality of unit cells (battery cells) 100a are electrically connected in series. The battery 100 and the unit cell 100a correspond to the “cell” of the present disclosure. The unit cell 100a may comprise, for example, a lithium-ion cell. In the present embodiment, an iron phosphate lithium-ion battery (LFP battery) using phosphorus (P), iron (Fe), and lithium (Li) as the positive electrode material is employed as the unit cell 100a.

The monitoring unit 200 includes a voltage sensor 210, a current sensor 220, and a temperature sensor 230. The voltage sensor 210 detects a voltage VB (a voltage VB between terminals of the unit cell 100a ) of the unit cell 100a. The current sensor 220 detects a current IB input to and output from the battery 100 (unit cell 100a). When the battery 100 is discharged, the current IB becomes a negative (−) value, and when the battery 100 is charged, the current IB becomes a positive (+) value. The temperature sensor 230 detects a temperature TB of each of the unit cell 100a. The sensor outputs the detected signal to the battery ECU 300.

Electrified vehicle 1 includes an inlet 60, and the battery 100 can be externally charged using electric vehicle supply equipment (EVSE) 400. The inlet 60 is configured to be connectable to a connector 420 provided at a distal end of EVSE 400 charge cable 410. The inlet 60 is electrically connected to a power line connected to the battery 100 via the charging circuit 70. In the present embodiment, when SMR 50 is closed, the inlet 60 and the battery 100 are connected to each other to enable external charging. The charging circuit 70 may include a charging relay. In addition, an inlet 60 (charging circuitry 70) may 20 be connected to a power line between the battery 100 and SMR 50 via a charging relay, and the charging relay may be closed, so that the battery 100 can be externally charged. A SMR 50 or charge relay corresponds to a “relay” of the present disclosure.

The battery ECU 300 includes a CPU 301 and a memory 302. The memory 302 includes non-volatile memory (e.g., flash memory). The battery ECU 300 estimates SOC of the battery 100 using the signal received from the monitoring unit 200, and outputs the estimated signal to the control ECU 500. The battery system S includes a battery 100 (unit cell 100a), a monitoring unit 200, a battery ECU 300, and the like.

The control ECU 500 includes a CPU 501 and memories 502. Memory 502 includes non-volatile memory (e.g., flash memory). The control ECU 500 controls the devices so that electrified vehicle 1 is in a desired condition based on signals received from the battery ECU 300, signals from various sensors (not shown) (e.g., accelerator operation amount signal, vehicle speed signal, and the like), maps and programs stored in the memory 502, and the like.

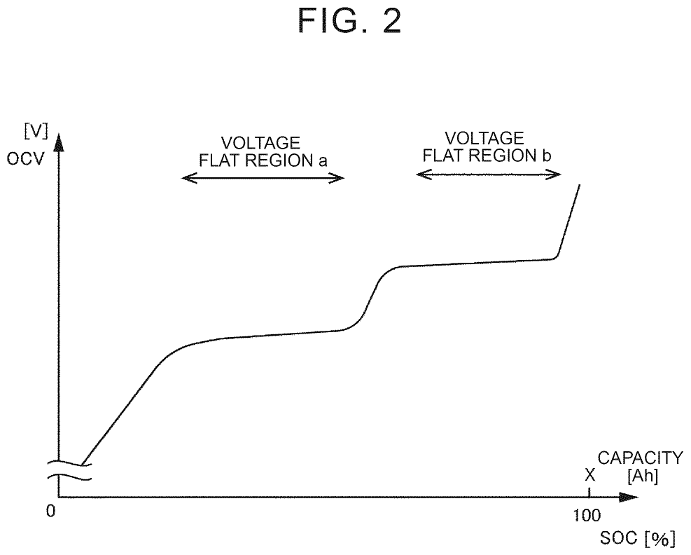

FIG. 2 is a diagram for explaining SOC-OCV properties of the unit cell (LFP cell) 100a of the present embodiment. In FIG. 2, the vertical axis represents OCV[V] of the unit cell 100a, and the horizontal axis represents SOC [%] of the unit cell 100a. As shown in FIG. 2, there is a wide range of regions (voltage-flat regions) in which SOC and OCV relations (hereinafter, this relationship is also referred to as “SOC-OCV property” or “OCV curve”) have a slight change in OCV and a small change in OCV curve with respect to the change in SOC. Therefore, in the voltage flat area, the estimation accuracy of SOC deteriorates when SOC of the battery 100 (unit cell 100a) is estimated based on SOC-OCV property using the voltage VB detected by the voltage sensor 210. Therefore, it is desirable to estimate SOC using the current integration method (Coulomb count method).

In the battery system S, the battery 100 may be replaced. When replacing the battery 100, it is desired to estimate SOC of the battery 100 after replacement. When the battery 100 is replaced, when SOC is estimated using the current integration method, a lot of times is required until SOC is estimated. For this reason, it is conceivable to detect the voltage VB when the battery 100 is replaced, and estimate SOC based on SOC-OCV property using the detected voltage VB. Here, it is preferable to estimate SOC by using the voltage VB detected after replacing the battery 100 and prior to the battery 100 being connected to the load. This is because the voltage VB prior to the battery 100 being connected to the load corresponds to OCV.

The fact that the battery 100 has been replaced is determined (detected) by, for example, the presence or absence of a battery replacement signal inputted from the service tool after the battery ECU 300 is started. Therefore, when the replacement of the battery 100 is detected, SMR 50 may be connected and the battery 100 may be connected to loads. In this case, even if SOC is estimated using the voltage VB detected by the voltage sensor 210 when the replacement of the battery 100 is detected, the estimation error of SOC may increase.

In the present embodiment, when it is detected that the battery 100 has been replaced and an SMR 50 (or a charging relay) connecting the battery 100 and the load is connected, the SOC estimated based on the SOC-OCV property is corrected based on a current discharged or charged via the SMR 50 (or a charging relay), thereby reducing the SOC estimation error.

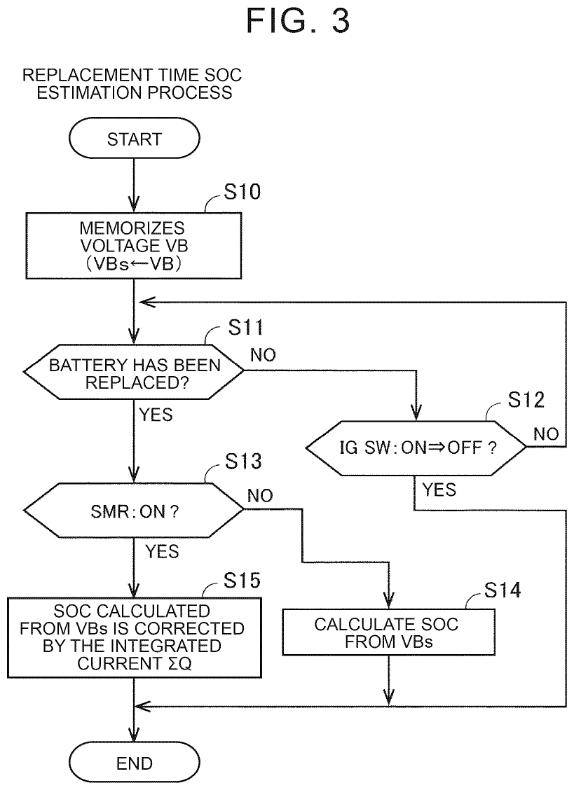

FIG. 3 is a flow chart illustrating an exemplary replacement time SOC estimation process performed by the battery ECU 300 in the present embodiment. This flow chart is executed when IG switch (power switch) 250 is turned on and the battery ECU 300 is activated. In step (hereinafter, step is abbreviated as “S”) 10, the voltage VB detected by the voltage sensor 210 is stored in the memory 302 as the starting voltage VBs.

In the following S11, it is determined whether or not the batteries have been replaced. For example, the control ECU 500 may determine that a battery replacement has occurred when receiving a replacement signal from a service-tool ST used by a replacement operator of the battery 100. When the identification number (ID) of the battery 100 stored in the memory 302 or the nonvolatile memory of the memory 502 differs from the identification number of the battery 100, it may be determined that the battery has been replaced. If the battery has not been replaced, the process proceeds to S12, and if the battery has been replaced, the process proceeds to S13.

In S12, it is determined whether or not IG switch 250 is operated from on to off. When IG switch 250 is turned off, the present routine is ended. When IG switch 250 is turned on, the process returns to S11, and it is determined whether or not the batteries have been replaced.

S13 determines whether or not SMR 50 (or charge relays) are connected (whether or not they are on-state). If SMR 50 is not connected (off-state), proceed to S14. If SMR 50 is connected, proceed to S15.

In S14, SOC of the unit cell 100a is calculated based on SOC-OCV property (FIG. 2) by using the starting-time-voltage VBs. All the unit cell 100a included in the battery 100 are calculated from the starting-voltage VBs of the unit cell 100a, and SOC of the unit cell is completed.

In S15, the starting voltage VBs is used to calculate SOC of the unit cell 100a based on SOC-OCV property (FIG. 2), and a value obtained by correcting this SOC with the current integrated value ΣQ is calculated as an SOC. When SOC of all the unit cell 100a is corrected by the current integrated value ΣQ and SOC is calculated, the present routine is ended.

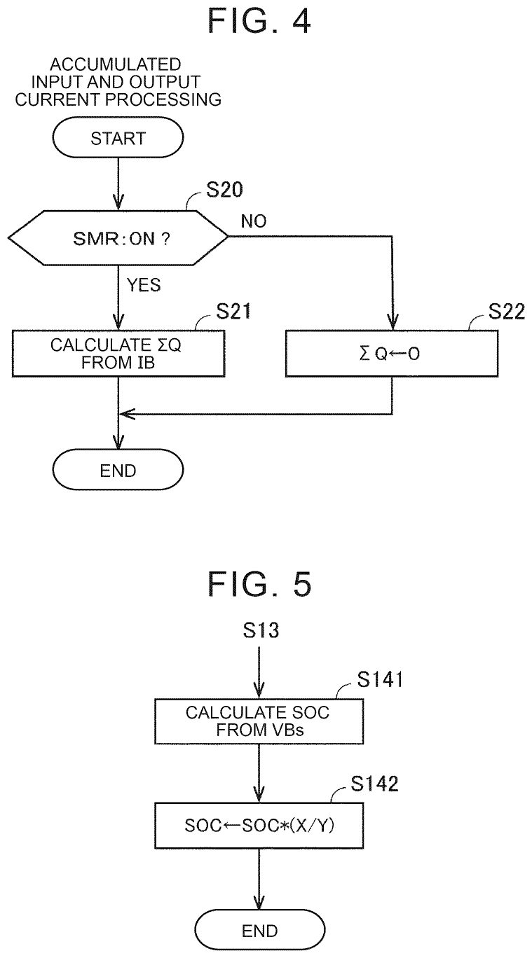

FIG. 4 is a flow chart illustrating an exemplary input/output current integration process performed by the battery ECU 300. This flow chart is repeatedly processed at predetermined intervals when the battery ECU 300 is activated. S20 determines whether SMR 50 is on-state. When SMR 50 is connected and in the ON state, the process proceeds to S21, and when SMR 50 is interrupted and in the OFF state, the process proceeds to S22.

In S21, the current integrated value ΣQ[Ah] is calculated by integrating the current IB detected by the current sensor 220, and then the present routine is ended. When the battery 100 is discharged, the current IB becomes a negative (−) value, and when the battery 100 is charged, the current IB becomes a positive (+) value. Therefore, the current integrated value ΣQ decreases during discharging and increases during charging. In S22, the current integrated value ΣQ is set to 0 (zero), and then the present routine is ended.

Referring to FIG. 3, in S15, SOC calculated based on SOC-OCV property is corrected using the integrated current ΣQ. When SOC calculated from SOC-OCV property is “SOC1”, it is calculated as “SOC=SOC1−(ΣQ/X)”. X[Ah] is the capacity (full charge capacity) of the unit cell 100a when SOC is 100 [%] in SOC-OCV property of FIG. 2, and is a preset value. After S14 and S15 estimate SOC, SOC may be calculated (updated as needed) by the current integration method using the current IB detected by the current sensor 220.

According to the present embodiment, when it is detected that the battery 100 has been replaced and a SMR 50 (or a charging relay) connecting the battery 100 and the load is connected, the starting voltage VBs is used to correct SOC-OCV property estimated SOC (SOC1) based on the current (current integrated value ΣQ) discharged or charged through SMR 50 (or the charging relay). Thus, after the battery 100 is replaced, the voltage VB (starting voltage VBs) detected prior to the battery 100 being connected to the load is used to estimate SOC from SOC-OCV property, and SOC is corrected based on the integrated current ΣQ charged and discharged via SMR 50 (or the charge-relay), so that SOC estimation error can be reduced.

### Second Embodiment

As a replacement battery, a used product or a rebuilt product may be used. If SOC is estimated based on OCV curve (SOC-OCV property) when the battery is new, the estimated SOC becomes smaller than the actual SOC, and there is a fear that the battery after replacement is overcharged. Therefore, when the replacement of the battery is detected, SOC may be calculated by switching OCV curve for calculating SOC and using OCV curve after the deterioration of the battery. OCV curve after degradation may be set according to a pre-assumed degradation condition, and for example, when a replacement of a battery is detected, SOC is calculated using an OCV curve whose capacity retention ratio corresponds to 75 [%].

Even when switching to OCV curve after deterioration, the deterioration state of the replaced battery may be different from the deterioration state assumed in advance. Therefore, it is desirable to accurately determine the deterioration degree (capacity retention ratio) of the battery after replacement. In determining the degree of degradation of the battery, it is preferable that the battery is discharged completely (SOC=0 [%]), and then charged to full charge to determine the full charge capacity.

The deteriorated state of the battery after replacement may be better than the assumed deteriorated state, and the full charge capacity of the battery after replacement may be greater than the full charge capacity of OCV curve after deterioration. Here, SOC calculated from the deteriorated OCV curve is calculated to be smaller than the actual SOC. Therefore, when the charging and discharging of the battery is controlled using the calculated SOC, even if the battery is discharged until SOC reaches 0 [%] in order to completely discharge the battery, the actual SOC may not reach 0 [%], and the full charge capacity of the battery after replacement may not be accurately calculated.

In the second embodiment, SOC at the time of battery replacement can be estimated so that the battery after replacement can be discharged until SOC becomes 0 [%]. FIG. 5 is a diagram illustrating a part of a flow chart of a replacement time SOC estimation process executed in the battery ECU 300 in the second embodiment. In the second embodiment, S14 of the flow chart shown in FIG. 3 is replaced with S141 and S142 shown in FIG. 5, and SOC used in S15 (FIG. 3) is replaced with SOC calculated in S142.

In S141, similarly to S14 (FIG. 3), SOC of the unit cell 100a is calculated based on SOC-OCV property (FIG. 2) using the starting-voltage VBs. When all the unit cell 100a included in the battery 100 are calculated from the starting-voltage VBs of the unit cell 100a, SOC proceeds to S142.

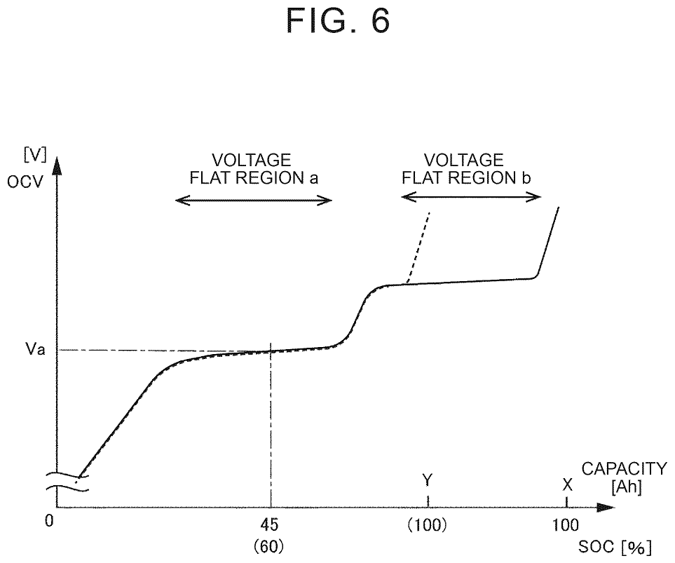

In S142, SOC calculated by S141 is corrected by using the full charge capacity X[Ah] in SOC-OCV characteristic (OCV curve) of FIG. 2 and the full charge capacity Y[Ah] of SOC-OCV characteristic (OCV curve) used in the charge-discharge control after the battery is replaced. FIG. 6 is a diagram for explaining an SOC-OCV property after replacement of a battery. In FIG. 6, the vertical axis represents OCV[V] of the unit cell 100a, and the horizontal axis represents SOC [%] of the unit cell 100a. In FIG. 6, OCV curve of the solid line is the same as OCV curve of FIG. 2, and is, for example, an OCV curve when the battery 100 is new. In FIG. 6, a OCV curve indicated by a broken line represents an SOC-OCV property for performing charge/discharge control of the battery 100 after the battery is replaced. In an LPF cell having a voltage-flat region, even if degradation occurs, there is almost no change in the low SOC region in OCV curve, and SOC curve of the solid line and OCV curve of the broken line overlap in the low SOC region.

In FIG. 6, X[Ah] is a capacity at SOC=100 [%] in OCV curve of the solid line, and is a full charge capacity of OCV curve of the solid line. The full charge capacity X corresponds to the “full charge capacity in SOC-OCV property” in the present disclosure. Y [Ah] is the capacity at SOC=100 [%] in OCV curve of the broken line, and is the full charge capacity of OCV curve of the broken line. The full charge capacity Y corresponds to the “full charge capacity at degradation” of the present disclosure. OCV curve of the broken line is set in advance to perform charge/discharge control of the battery 100 after the battery is replaced, and for example, the capacity retention ratio may correspond to 75 [%] with respect to OCV curve of the solid line. In this instance, “X/Y=1.33” is obtained.

In S142, SOC is corrected by multiplying SOC calculated by S141 by “X/Y” (SOC←SOC×(X/Y). When SOC of all the unit cell 100a included in the battery 100 is corrected, the present routine is ended.

Note that, in the second embodiment, SOC used in S15 (FIG. 3) is replaced by SOC calculated in S142. A value obtained by correcting this SOC with the current integrated value ΣQ is calculated as an SOC, and when the SOCs of all the unit cells 100a are corrected with the current integrated value ΣQ, the present routine is ended.

In the second embodiment, when the battery is replaced, SOC is estimated based on SOC-OCV property using the starting voltage VBs detected by the voltage sensor 210. Then, SOC is corrected by using the full charge capacity X and the full charge capacity Y. For example, as shown in FIG. 6, when the starting voltage VBs is Va, SOC estimated based on SOC-OCV property (solid line) is 45 [%], and when the capacity retention ratio of OCV curve (dashed line) set in advance to perform the charge and discharge control of the battery 100 after the battery is replaced is 75 [%], SOC is 60 [%](=45×1.33) because it is “X/Y=1.33”. Therefore, the actual SOC can be discharged to 0 [%] by discharging from SOC=60 [%] to complete discharge (SOC=0 [%]) using a OCV curve (dashed line). As a result, the full charge capacity of the battery 100 after the replacement can be accurately calculated by charging to full charge after the complete discharge. After calculating the full charge capacity of the battery 100 after replacement, SOC is estimated by a new OCV curve using the full charge capacity. Further, SOC may be estimated by using the current integration method in combination.

The replacement battery is generally distributed with SOC in the low SOC range in order to suppress degradation or the like. When OCV curve in the low SOC range is changed due to the deterioration state of the battery when SOC is estimated using OCV curve after the deterioration set in advance, a large error occurs in the estimated SOC when the battery after the replacement is different from the deterioration state of OCV curve set in advance. Therefore, the actual SOC cannot be discharged to 0 [%]. In an LPF cell having a voltage-flat region, even if degradation occurs, there is little change in OCV curve in the low SOC region. Therefore, even when the full charge capacity of the battery after replacement is different from the full charge capacity Y (the full charge capacity after degradation) set in advance, the actual SOC can be discharged to 0 [%] by correcting SOC using the full charge capacity X and the full charge capacity Y.

In the second embodiment, S13 and S15 of the flow chart shown in FIG. 3 may be omitted, and S141 and S142 may be processed when an affirmative determination is made in S11.

Embodiments of the present disclosure include the following configurations.
1) A battery system includes a battery, a voltage sensor for detecting a voltage of the battery, and a control device for estimating an SOC of the battery, wherein SOC-OCV property of the battery has a voltage flat area having a small change in OCV with respect to an SOC, and the control device is configured to estimate an SOC based on an SOC-OCV property using a voltage detected by the voltage sensor when the battery is replaced, to correct SOC using the full charge capacity X in SOC-OCV property and the full charge capacity Y in SOC-OCV property when the battery is deteriorated, and to perform discharging so that the battery is completely discharged using the corrected SOC and SOC-OCV property when the battery is deteriorated.
2) The battery system In 1, in which the control device is configured to calculate the full charge capacity of the battery after replacement by charging the battery to full charge after the battery has been completely discharged.

In the above-described embodiment, an iron phosphate lithium-ion battery (LFP battery) is employed as the unit cell 100a. However, the unit cell 100a may be another type of cell as long as the cell has a small region (voltage-flat region) in which OCV curve changes.

The vehicle to which the battery system S is applicable is not limited to electrified vehicle 1 of FIG. 1. For example, the present disclosure is also applicable to a plug-in hybrid electric vehicle including an engine and a motor generator, and is also applicable to a fuel cell electric vehicle including a storage battery and capable of being externally charged. Alternatively, the vehicle may be an industrial vehicle such as a forklift. The battery system S may be a stationary battery.

The embodiment disclosed herein shall be construed as exemplary and not restrictive in all respects. The scope of the present disclosure is defined not by the above description of the embodiments but by the claims, and is intended to include all possible modifications within a scope equivalent in meaning and scope to the claims.

What is claimed is:

1. A battery system comprising:
a battery;
a voltage sensor that detects a voltage of the battery; and
a control device that estimates a state of charge (SOC) of the battery, wherein:
the control device is configured to, when it is detected that the battery has been replaced,
estimate the SOC based on an SOC-open circuit voltage (OCV) property of the battery using the voltage detected by the voltage sensor, and
when a relay that connects the battery and a load is connected, correct the SOC estimated based on the SOC-OCV property based on a current discharged or charged via the relay.

2. The battery system according to claim 1, wherein:
a degradation-time full charge capacity is set in advance as a full charge capacity of the battery at a time when the battery is degraded; and
the control device is configured to correct the SOC estimated based on the SOC-OCV property using a full charge capacity in the SOC-OCV property and the degradation-time full charge capacity.

3. A battery system comprising:
a battery;
a voltage sensor that detects a voltage of the battery; and
a control device that estimates a state of charge (SOC) of the battery, wherein:
the control device is configured to, when the battery is replaced,
estimate the SOC based on an SOC-open circuit voltage (OCV) property of the battery using the voltage detected by the voltage sensor, and
correct the SOC using a full charge capacity in the SOC-OCV property and a degradation-time full charge capacity as a full charge capacity at a time when the battery is degraded; and
the degradation-time full charge capacity is set in advance.

4. The battery system according to claim 1, wherein the SOC-OCV property of the battery has a flat voltage area in which variations in an OCV with respect to the SOC are small.

5. The battery system according to claim 3, wherein the SOC-OCV property of the battery has a flat voltage area in which variations in an OCV with respect to the SOC are small.

6. The battery system according to claim 1, wherein a signal indicating that the battery has been replaced is input from a service tool.

7. The battery system according to claim 3, wherein a signal indicating that the battery has been replaced is input from a service tool.
